(19) United States
(12) Patent Application Publication
(10) Pub. No.: US 2025/0026112 A1
(43) Pub. Date: Jan. 23, 2025

(54) Structural Reinforcement of Reusable Plastic Foam Laminates and Kits

(71) Applicant: Mark A. Shippen, Prattville, AL (US)

(72) Inventor: Mark A. Shippen, Prattville, AL (US)

(21) Appl. No.: 18/356,365

(22) Filed: Jul. 21, 2023

(51) Int. Cl. B32B 27/06; B32B 5/02; B32B 5/18; B32B 7/06; B32B 7/14; B32B 27/08; B32B 27/12; B32B 27/28; B32B 27/30; B32B 27/36

(52) U.S. Cl. CPC B32B 27/065; B32B 5/02; B32B 5/18; B32B 7/06; B32B 7/14; B32B 27/08; B32B 27/12; B32B 27/283; B32B 27/304; B32B 27/308; B32B 27/36; B32B 2250/05; B32B 2262/0261; B32B 2307/304; B32B 2307/31; B32B 2307/4026; B32B 2307/412; B32B 2307/7376; B32B 2307/748; B32B 2419/00; B32B 2451/00

(57) ABSTRACT

To improve and reinforce the structural integrity of plastic foam laminates, a new plastic sheet member is now laminated within. Plastic foam laminates are used to insulate architectural glass making the glass about 90% to 99% insulated which directly affects global climate change. Typical energy savings of 40% or more of the heating and cooling load in a US residential home is achievable with substantial energy savings in nonresidential applications.

### FIELD OF INVENTION

With windfall climate change remaining a certainty, this new field of emerging technology addresses plastic foam laminates of the tape type and full adhesive type. Plastic foam laminates can stop heat transfer through architectural glass by about 90-99% when the foam thickness is 6.35 mm (0.25 inch). These laminates include the adhesive or heat seal lamination type. However, as plastic foam laminates are used for many years, problems with western sun exposure have been observed. Such extensive sun exposure makes the decorative face of these laminates rip up upon removal or leave adhesive residue. Unwanted, hot weather cavitation with air pocket expansion in the tape type is a fatal flaw. Now, a lay flat on glass reinforcement is achieved for western exposures. Consumers really value the improve “stained glass” appearance of removable, reusable laminates and an unexpected reduction in adhesion. Large windows, especially commercial require applications with minimal unsightly adhesive contact marks. Thus, this application adds reinforcements to the plastic foam laminate structures to, eliminate these unwanted flaws and create high value plastic foam laminates. When supplied in simple kits, unskilled users will fabricate numerous, repeatable, removable, and reusable laminate designs in their own homes.

Embodiments. The main embodiment is a plastic foam laminate requiring structural improvement. The preferred way to remedy such a deficiency is to add a new reinforcement layer of plastic like petg, vinyl, pet, polyester, heat activated polyester, polyvinyl acetate, pvc, heat activated pvc, polycarbonate, polyethylene, polypropylene, Dura-lar™ or comprising adhesive coated plastics up to 30 mils (0.762 mm). Also, adhesive coated plastic films such as clear, translucent, matte, or frosted are useful. An optional, 1.5 to 3 mil (0.038 mm to 0.076 mm) heat seal reinforcing film applied to the plastic foam on one or both sides improve the rigidity and room side image. This inclusion reduces the adhesion on glass and improves the presentation.

The added reinforcing member may require UV sunlight protection while achieving excellent resiliency and shear strength. Such semi-rigid or stiff sheets improve the appearance of the article by making it completely planar, lay flat on glass, increase the structural integrity, and achieve better removability. Also, the plastic foam laminates comprise optional decorative films including plastics like vinyl, colorized vinyl, printed vinyl, graphical film, polyolefin, polyvinyl acetate, or even decorative border tape. A “stained glass” look with low-cost plastic film is realized. It should be noted that a ¼ inch (6.35 mm) thick specification for most residents allows the windows to slide open without removing the article. Similarly, sliding glass doors have clearance. Immovable glass and residential bottom windows can utilize thicker foam.

Adding a 5 mil (0.127 mm) reinforcing sheet to the plastic foam laminates reduces adhesion by approximately 50% to the glass. However, dusting this laminate's adhesive surface with an inert particulate disclosed in Shippen (US 2019-0084272) can reduce aggressive adhesion and attain removability and reusability from architectural glass. When it becomes necessary to process different adhesive films from different manufactures, this processing method expands the use of different adhesive strengths. Therefore, this article now achieves cleaner removability and reusability. These reinforcing sheets about 10 mils (0.254 mm) thick can increase the laminate's stiffness and improve the laminate's clean removal from architectural glass. Mounting these laminate sheets are easier than cutting and taping flimsy heat shrink films which wrinkle and sag yielding dubious insulation value.

Another property of the structural reinforced plastic sheet reduces shrinkage. The inner applied, plastic decorative films are subject to shrinkage especially on the western sun exposures. Because of the newly created rigidity and reinforcement with the plastic sheet, a desirable planar shape can be maintained which mitigates plastic shrinkage issues even at high temperature applications exposed to western facing glass. Also, specifying up to 0.50 inch (12.70 mm) thick foam makes the plastic foam laminates sheet-like yielding similar, desirable adherent properties. Additionally, with thick foam, it is quite feasible to decorate both sides of the plastic foam enhancing the article's appearance by blocking color bleed through whether viewed from the inside or outside; commercial use is anticipated.

An additional, optional embodiment is a roll of double-sided adhesive tape. For clarity, the references to “adhesive” in this specification describe an adhesive composition, a transfer tape, a single-sided tape, a double-sided tape, or any combination thereof. Because the structural integrity is improved, adhesive tapes such as acrylics, silicones, elastomers, transfer tapes, butyl rubber and combinations about ¼ to ¾ inches (6.35 to 19 mm) wide are taped about the laminate's glass side periphery creating an adhesive seal. When a silicone adhesive composition is selected, this material is waterproof and UV resistant for 10 years pliability; if a fiberglass, aluminum, copper, or metalized plastic carrier film is selected, the resultant mount becomes almost UV indestructible. The standard carrier film, however, is polyester. It is noted that double sided differential tapes, adhesive tapes and transfer tapes or combinations thereof can comprise any pattern including a total, full surface deposition. Full surface adhesion requires silicone-based adhesives with a nylon tulle fabric cover film. Every adhesive directly contacting glass should be repeatably removable and reusable with direct adhesion to architectural glass and never damage the removed article of insulation. Using such tape types which are adhered around the perimeter of the article creates an effective seal to glass and conserves silicone adhesive. Inclusions in simple kits are feasible and cost effective. Strong adhesives are required for the inner glass side adhesive layers to prevent ply separation. Nominal corner tape tabs securing front and back sides prevent ply failures doubling utility.

Additionally, an optional decorative film permanently adhered, or a removable interchangeable film is useful. Decorative films that simulate stained glass are commonly available with or without an adhesive coating. For instance, a matte or frosted exterior film makes the outside view like white blinds. Transparent colorized films like Oracal 8300™ allow the color to project through the foam at night when the interior is illuminated. Articles comprising optional decorative plastic films including polyolefin, pvc, colorized vinyl, printed vinyl, graphical film, polyvinyl acetate, decorative border tape, d-c-fix™ window films and commercial graphics all of which can be removable and reusable when placed on either side of the article. Decorative border tape in roll form is adhered to the article obscuring any adhesive contact marks on the glass. Such tape is adhesive free or coated on one or both sides. In contrast, decorative transparent colored films have dimpled surface flaws without the plastic reinforcement of the present art. Reinforcement films like translucent, d-c-fix Pearl, Prism (346-0275) or Dura-lar™ can obscure superficial blemishes creating glass like solid colors. A secondary reinforcement layer such as a heat seal lamination film increases the rigidity and reduces the adhesion to glass. Since stained glass enhances the beauty in cathedrals, removable, reusable and interchangeable insulating sheets have new utility when mounted on architectural glass. Original artwork is drawn on the decorative film with permanent, colored artwork markers such as the trade names, “Sharpie”, “Staedtler” and “INC”. Note Example 4.

### EXAMPLE ONE

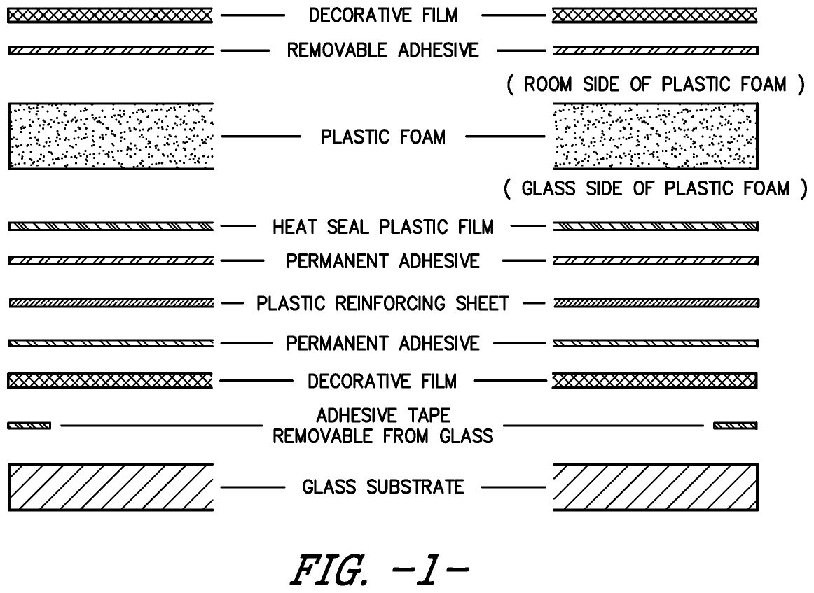

A plastic film about 10 mils (0.258 mm) such as petg, polycarbonate or Dura-far™ is utilized on the plastic foam laminate's glass side as a reinforcement according to FIG. 1. Optionally, one or two sides of heat seal film can be used. Oracal 8300™ decorative film in 30 transparent colors is available for the glass or room side. The basic kit of this design requires the tape type plastic foam laminate and a roll of double-sided adhesive tape such as a silicone or differential silicone/acrylic type which minimizes adhesive contact with glass. The kit tape is claimed as an option. A glue such as Elmer's™ extra strength glue stick is safe, nontoxic, water based and tested for 5 years adheres the decorative film to the room side foam. A room side decorative film with or without an adhesive coating may be included in the kit as well as a suitable glue stick or glue tube. Note Example 4.

### EXAMPLE TWO

A plastic sheet such as 20 mil (0.508 mm) pvc is added to a plastic foam laminate structure according to FIG. 1 which increases the rigidity and inhibits summer cavitation. A decorative film located exteriorly absorbs most of the UV light. Note Example 4.
heat seal reinforcing film (1.7 mils) (0.049 mm))
plastic foam (¼ inch (6.35 mm))
heat seal reinforcing film 3 mils (0.076 mm))
adhesive (strong double sided mounting adhesive)
reinforcing sheet (20 mils (0.58 mm) pvc film)
adhesive (strong adhesive furnished on the decorative film)
decorative film (d-c-fix™ window film)
adhesive tape removable (tape optioned in claim 1) removable from glass

### EXAMPLE THREE FOLLOWS EXAMPLE 12

Another design is the full adhesive type of plastic foam laminate. Herein, a full coverage of adhesive, preferably silicone, is deposited on the glass side surface of the plastic foam laminate. A 5-mil reinforcing sheet reduces the adhesion of the article by approximately 50% thereby creating repeatable, removable, reusable adhesion to glass.
plastic foam (¼ inch (6.35 mm))
heat seal reinforcing film (3 mils (0.076 mm))
adhesive (strong double sided)
reinforcing sheet (5 mils (0.127 mm)) with UV
resistant Dura-lar™)
adhesive (strong furnished on the decorative film) such as Oracal 8300™
adhesive removable from glass such as the
(option in claim 1)
nylon tulle fabric (easy release cover film)

### EXAMPLES 4-19

Also, due to adhesive procurement, “adhesive” in Examples 5-15, 18, 19 describes an adhesive composition, a transfer tape, a single sided tape or a double-sided tape or combinations thereof. Both adhesive lamination and heat seal lamination are represented in Examples 4-19. Examples 8, 9, 16, 16, 17 show the reinforcing sheets facing the room side.

### Tape Types

### EXAMPLE 4

Plastic foam
Reinforcing heat seal film
Adhesive
Reinforcing sheet
Adhesive
Decorative film
Adhesive tape removable from glass

### EXAMPLE 5

Plastic foam
Adhesive
Reinforcing sheet
Adhesive
Decorative film
Adhesive tape removable from glass

### EXAMPLE 6

Plastic foam
Reinforcing heat seal film
Adhesive
Decorative film
Adhesive
Reinforcing sheet
Adhesive tape removable from glass

### EXAMPLE 7

Plastic foam
Adhesive
Decorative film
Adhesive
Reinforcing sheet
Adhesive tape removable from glass

### EXAMPLE 8

Adhesive tape removable from glass
Reinforcing heat seal film
Plastic foam
Heat seal film
Adhesive
Decorative film
Adhesive
Reinforcing sheet

### EXAMPLE 9

Adhesive tape removable from glass
Reinforcing heat seal film
Plastic foam
Adhesive
Decorative film
Adhesive
Reinforcing sheet

### EXAMPLE 10

Plastic foam
Adhesive
Reinforcing sheet
Adhesive tape removable from glass

### EXAMPLE 11

Plastic foam
Reinforcing heat seal film
Adhesive
Reinforcing sheet
Adhesive tape removable from glass
Full Adhesive Types

### EXAMPLE 12

Plastic foam
Reinforcing heat seal film
Adhesive
Reinforcing sheet
Adhesive
Decorative film
Full adhesive removable from glass

### EXAMPLE 13

Plastic foam
Adhesive
Reinforcing sheet
Adhesive
Decorative film
Full adhesive removable from glass

### EXAMPLE 14

Plastic foam
Reinforcing heat seal film
Adhesive
Decorative film
Adhesive
Reinforcing sheet
Full adhesive removable from glass

### EXAMPLE 15

Plastic foam
Adhesive
Decorative film
Adhesive
Reinforcing sheet
Full adhesive removable from glass

### EXAMPLE 16

Full adhesive removable from glass
Reinforcing heat seal film
Plastic foam
Heat seal film
Adhesive
Decorative film
Adhesive
Reinforcing sheet

### EXAMPLE 17

Full adhesive removable from glass
Reinforcing heat seal film
Plastic foam
Adhesive
Decorative film
Adhesive
Reinforcing sheet
Commercial Applications

### EXAMPLE 18

Plastic foam
Reinforcing heat seal film
Adhesive
Reinforcing sheet
Adhesive tabs.
Decorative film
Adhesive tape removable from glass

### EXAMPLE 19

Plastic foam
Adhesive
Reinforcing sheet
Adhesive tabs
Decorative film
Adhesive tape removable from glass

The advantage of a substantially adhesive free decorative film is that it can be interchanged easily achieving unmatchable glass side clarity. In short, these two Examples 18, 19 can be described for the first time as “inlayed and sealed to glass”. Adhesive tabs cut from the tape roll prevent film slippage prior to mounting. If the decorative materials are first affixed to glass, then the insulating article functions as a press and seal overlay. Therefore, any existing glass graphics can be overlapped and insulated very effectively. Substantial energy savings is added now whereas existing commercial graphics have practically none.

### Room Side Layers

Decorative film
Adhesive
Reinforcing heat seal film
Plastic foam
Decorative film
Adhesive
Plastic foam

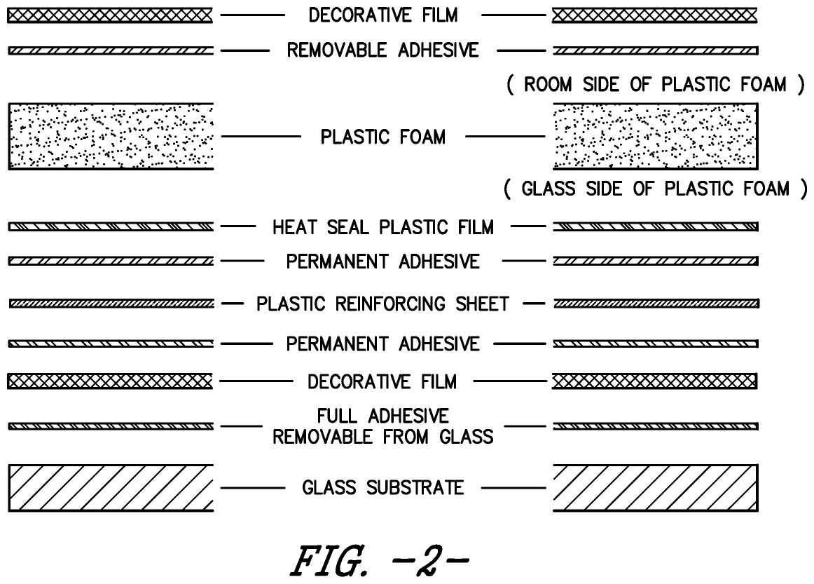

### FIGS. 1-2.

FIG. 1 represents the tape type and shows a cross-sectional view with the added reinforcing plastic sheet is located interiorly so that the decorative film faces sun ward for the best simulated stained glass. This requires the decorative film to absorb the UV light exposure and must be UV stabilized. Note Examples 4-7 Of course, an additional room side polyester film heat lamination enhances the adhesion of decorative materials and improves the rigidity of the article.

FIG. 2 shows a cross-sectional view with the added reinforcing plastic sheet or film. This represents the full adhesive structure. Note Examples 12-15. Of course, an additional room side polyester film heat lamination reduces adhesion and provides an improved surface for mounting decorative material.

### Kits.

Perhaps these foam laminate structures are most useful when included in kits. This will let the users measure, cut, and tape the laminates to specific sizes of glass or let the users apply the laminates to their desired applications. The old drafting note “field to fit” is applicable. These envisioned kits contain double sided tape or glue. Also, decorative films specified for the room side improves interior decorating. A simple, safe glue stick such as Elmer's is included in the kit to removably adhere decorative material including plastic films to the room side foam's surface. A low-density polypropylene foam sheet is useful. It is further envisioned that the room side decorative plastic film when removed, reused, or changed out as easy as it is to re-adhere the film to the foam. It should be noted the best time is nighttime to mount colored films so that any bubbles revealed by artificial light can be effectively removed to achieve the best appearance. Of course, an additional room side polyester heat lamination on the foam enhances the mounting of decorative materials. Specifying a roll of type of application to the periphery of the insulating article conserves silicone adhesive. A 0.75 (19 mm) wide decorative border tape such as holographical tape which hides the silicone type contact points when adhered to glass is very useful.

### SUMMARY

Conveniently, these new glass like plastic foam laminates of the tape type and the full adhesive type are cut easily with hand scissors or die-cut into diverse shapes. These improved plastic foam laminates weather the harsh western sun exposures better, maintain a semi-rigid, planar position on the glass, reduce the adhesive load, be removable after many years of insulation service, increase the structural strength, withstand unwanted shrinkage, and provide the highly desired “stained glass” look using plastic materials. Tape mounting is now improved. HVAC savings of 40% or more in a US home creates a cash windfall given the typical home has about 100 square feet or (9.29 square meters) of architectural glass. Additionally, nonresidential glass insulation savings will be significant and substantial. Achieving an estimated ten years of reusable service, this material will be an incredible investment for energy consumers and a windfall of energy savings all over the world. This one invention certainly affects global climate change solutions profoundly.

I claim:

1) A structurally improved plastic foam laminate article for removable, reusable insulation on architectural glass reducing glass heat transfer by about 90% or more comprising:
a) a plastic foam layer at least ¼ inch (6.35 mm) thick and;
b) an optional heat seal layer on the glass side of the said plastic foam and;
c) at least one reinforcing layer on either side of the said plastic foam and;
d) an optional plastic film decorative layer and;
e) at least one inner glass side adhesive layer and;
f) an optional exposed adhesive layer removable and reusable from architectural glass.

2) The plastic foam laminate of claim 1 wherein a reinforcing plastic sheet comprises plastic from the group including petg, vinyl, pvc, heat sealable pvc, polyester, heat sealable polyester, polyethylene, polypropylene, decorative film, Dura-lar™, and polycarbonate.

3) The plastic foam laminate of claim 1 wherein the optional plastic film decorative layer comprises a film with or without an adhesive coating and is chosen from the group including plastic film, polyolefin, polyvinyl acetate, vinyl film, colonized vinyl film, printed film, graphical film, Oracal 8300™, d-c-fix window Film™, border tape, or commercial graphics.

4) The plastic foam laminate of claim 1 wherein the exposed, removable, reusable adhesive layer applicable to architectural glass comprises a particulate deposition on at least part of the said exposed adhesive layer.

5) The plastic foam laminate of claim 1 wherein the layer of removable, reusable adhesive applicable to architectural glass comprises an adhesive composition including a butyl rubber, acrylic, or a silicone adhesive composition further comprising an adhesive transfer tape, a single sided adhesive tape, a double-sided adhesive tape; or a combination of adhesive layers of this list.

6) The plastic foam laminate of claim 1 wherein the inner glass side adhesive layer of said plastic foam laminate comprises a strong acrylic or silicone adhesive composition.

7) The plastic foam laminate of claim 1 wherein the plastic foam laminate of glass insulation functions as a press and seal overlay for decorative material or commercial graphics.

8) The plastic foam laminate of claim 1 wherein the layer of removable, reusable adhesive applicable to architectural glass comprises a cover film of nylon, tulle fabric.

9) The plastic foam laminate of claim 1 wherein the plastic film decorative layer is interchangeable.

10) The plastic foam laminate of claim 1 wherein the optional heat seal layer comprises a heat activated polyester film.

11) A kit creating a removable and reusable article of a plastic foam laminate glass insulation for mounting on architectural glass and comprising at least one reinforcing layer.

12) The kit combination of claim 11 wherein the reinforcing plastic sheet comprises material from the group including petg, pvc, heat sealable pvc, polyester, heat sealable polyester, polyethylene, polypropylene, Dura-lar™, polyvinyl acetate or polycarbonate.

13) The kit combination of claim 11 including a roll of double sided adhesive tape or said tape is adhered around the perimeter of the article creating an effective seal to glass wherein said tape comprises silicone, acrylic adhesive, butyl rubber or a combination of the said adhesives and is removable from direct adhesion to architectural glass.

14) The kit combination of claim 11 wherein the plastic foam laminate comprises one or more strong adhesive inner layers.

15) The kit combination of claim 11 including a removable, reusable decorative or interchangeable film with or without an adhesive layer and is chosen from the group including plastic film, vinyl film, colorized vinyl film, printed film, graphical film, Oracal 8300™, d-c-fix window film™, border tape or commercial graphics.

16) The kit combination of claim 11 including an adhesive glue stick or a tube of adhesive.

17) The kit combination of claim 11 wherein the roll of double-sided adhesive tape comprises a UV indestructible carrier film such as aluminum, copper, metal, metalized or fiberglass film.

18) The kit combination of claim 11 including artwork markers.

19) The kit combination of claim 11 including border tape selected to hide adhesive contact marks when adhered to glass comprising adhesive free, single sided adhesive or double-sided adhesive or wherein the border tape is adhered directly to the periphery of the plastic foam laminate.

20) The kit combination of claim 11 wherein the plastic foam laminate of glass insulation functions as a press and seal overlay for decorative material or commercial graphics.
